(19) United States
(12) Patent Application Publication
(10) Pub. No.: US 2026/0340153 A1
(43) Pub. Date: Oct. 29, 2026

(54) DATA GOVERNANCE METHOD, APPARATUS AND ELECTRONIC DEVICE BASED ON DATA LINEAGE

(71) Applicant: Qizhidao Technology Co., Ltd., Shenzhen (CN)

(72) Inventor: Quanfei ZHANG, Shenzhen (CN)

(21) Appl. No.: 19/663,535

(22) Filed: Apr. 30, 2026

Related U.S. Application Data
(63) Continuation of application No. PCT/CN2026/070442, filed on Jan. 5, 2026.

(30) Foreign Application Priority Data
Mar. 25, 2025 (CN) 202510359700.8

(51) Int. Cl. G06F 21/60; G06F 16/215; G06F 16/901

(52) U.S. Cl. CPC G06F 21/60; G06F 16/215; G06F 16/9024

(57) ABSTRACT

Disclosed are data governance method, apparatus and electronic device based on data lineage. The method comprises: acquiring metadata of target data corresponding to a target governance requirement; constructing a data lineage graph of the target data according to the metadata; calculating, based on the data lineage graph, a data quality propagation score, a data lineage path complexity, a data global impact score, a data leakage risk score, and a data usage efficiency score of the target data; generating a comprehensive data governance score based on the data quality propagation score, the data lineage path complexity, the data global impact score, the data leakage risk score, and the data usage efficiency score; and performing data governance on the target data according to the comprehensive data governance score.

### CROSS-REFERENCE TO RELATED APPLICATIONS

This application is a continuation of PCT/CN2026/070442, filed Jan. 5, 2026, and claims priority of Chinese Patent Application No. 202510359700.8, filed on Mar. 25, 2025. The entire contents of PCT/CN2026/070442 and Chinese Patent Application No. 202510359700.8 are incorporated herein by reference.

### TECHNICAL FIELD

The present application relates to the technical field of data governance, and in particular, to a data governance method, apparatus and electronic device based on data lineage.

### BACKGROUND

In modern data governance processes, the importance assessment of data is a key step in formulating governance strategies, allocating resources, and optimizing data management processes.

Currently, the importance degree of data is determined by artificial rule of thumb or simple qualitative analysis. For example, governance priorities are directly assessed artificially based on departmental attribution, usage frequency, or business requirements of the data. However, this qualitative method lacks a unified quantitative standard, resulting in relatively high subjectivity and inconsistency in assessment results, making it difficult for such a method that solely relies on manual assessment of data governance priorities to meet the demand for precise governance.

Therefore, a data governance method and apparatus based on data lineage, and an electronic device are urgently needed.

### SUMMARY

The present application provides a data governance method, apparatus and electronic device based on data lineage, for facilitating precise governance of data.

A first aspect of the present application provides a data governance method based on data lineage, comprising: acquiring metadata of target data corresponding to a target governance requirement; constructing a data lineage graph of the target data according to the metadata; calculating, based on the data lineage graph, a data quality propagation score, a data lineage path complexity, a data global impact score, a data leakage risk score, and a data usage efficiency score of the target data; generating a comprehensive data governance score based on the data quality propagation score, the data lineage path complexity, the data global impact score, the data leakage risk score, and the data usage efficiency score; and performing data governance on the target data according to the comprehensive data governance score.

By adopting the above technical solution, multiple key factors such as data governance quality, complexity, security, and efficiency are comprehensively considered through the data quality propagation score, the path complexity, the global impact score, the data leakage risk score, and the usage efficiency score, avoiding the one-sidedness of single-indicator assessment. It can meet quality optimization requirements while taking into account efficiency improvement and security risk control, adapting to governance requirements in different scenarios. By quantifying various scores, an objective basis for data priority assessment is provided, avoiding subjective bias in traditional qualitative methods. The construction of the data lineage graph provides visualization and precise analysis of data dependency relationships, ensuring complete depiction of data flow paths and influence scopes. Using multiple indicators to generate a comprehensive score provides a unified governance priority ranking, helping to rationally allocate governance resources and enhancing scientific decision-making. The weights can be dynamically adjusted according to requirement changes or indicators, and the comprehensive score can be updated in real time to adapt to governance objectives at different stages. Through automatic construction of the data lineage graph and indicator calculation, high efficiency in data assessment is achieved, reducing manual intervention and improving analysis speed. Comprehensive score-driven priority governance ensures that governance resources are concentrated on the most important data, improving overall efficiency and benefits of governance. The data leakage risk score helps to identify potential security risks in advance, reducing data leakage and compliance risks. Key data is identified through the global impact score to avoid cascading business risks caused by erroneous operations on important data. Therefore, precise governance of data is facilitated.

Optionally, the constructing a data lineage graph of the target data according to the metadata comprises: parsing the metadata to obtain data entities, wherein the data entities comprise database tables, fields, and files; extracting edges according to data entities having dependency relationships among a plurality of the data entities; acquiring additional data between the data entities and the edges; determining attributes according to the additional data; and constructing the data lineage graph of the target data based on the data entities, the edges, and the attributes.

By adopting the above technical solution, data entities such as database tables, fields, and files are uniformly parsed, ensuring that the construction of the data lineage graph covers the full path of data flow. By extracting dependency relationships among entities, the upstream and downstream flow and correlation of data are revealed, providing support for comprehensively tracking data sources and impacts. Using additional data to determine attributes further supplements detailed information of the data lineage graph, making the semantics of the graph clearer. By parsing dependency relationships among entities, it ensures that the generation of edges is based on actual data flow logic, avoiding redundant or misleading information. The introduction of attributes enables the data lineage graph not only to display data entities and dependency relationships, but also to provide contextual information, supporting more precise analysis. Using metadata parsing and automatic extraction of dependency relationships greatly reduces manual involvement and improves construction efficiency. The constructed data lineage graph can directly serve multi-dimensional calculations such as data quality propagation and global impact analysis, significantly enhancing data governance decision-making efficiency. By combining entities, edges, and attributes, complex metadata relationships are presented in a structured graph form, facilitating understanding and operation. The constructed lineage graph can be visualized through graphical tools, making it convenient for data governance teams to quickly locate key data and dependency paths. Additional attributes in the lineage graph support dynamic updates with business changes, ensuring its timeliness and practicality. The method supports multiple data entities (such as tables, fields, files), adapting to complex governance requirements of different data sources.

Optionally, the data quality propagation score is calculated by using the following formula:

$$Q = \frac{{\sum }_{i = 1}^{n} {q}_{i}}{n} \cdot {\prod }_{e ∈ E} ( 1 - d ( e ) )$$

wherein Q is the data quality propagation score, i is an i-th metadata item, qᵢ is a quality score of the i-th metadata item, n is a total number of metadata items, e is an edge, e∈E represents a set of edges in a path, and d(e) is a quality attenuation rate of a path edge e.

By adopting the above technical solution, through formula calculation, the originally vague problem of data quality propagation is converted into a specific numerical value, providing a basis for objective assessment. Combining the quality score of each metadata item and the quality attenuation rate of edges on the path, changes in data quality during the flow process are comprehensively considered, reflecting actual conditions. The introduction of the quality attenuation rate of path edges accurately captures the quality loss of data during complex flow processes, solving the problem in traditional methods of insufficient estimation of data transmission impact. The method can adapt to complex data lineage graph structures with multiple paths and multiple nodes, flexibly applied to various complex data environments. Based on the quality propagation score, key nodes or paths with low quality or high attenuation can be quickly located, helping to prioritize governance of problematic data. Through quantitative analysis results, governance resources are centrally allocated to critical paths and nodes, improving overall governance efficiency. The formula is based on dynamic data input and can be updated in real time as data quality and flow conditions change, adapting to governance requirements at different time points. By providing a quantitative diagnosis of data quality, it assists decision-makers in determining which paths or nodes have the greatest impact on overall quality. The data quality propagation score can serve as a priority reference indicator for data governance, providing strong support for governance planning.

Optionally, the data lineage path complexity is calculated by using the following formula:

$$L = {\sum }_{e ∈ E} w ( e , t ) \cdot f ( v )$$

wherein L is the data lineage path complexity, t is a time instant, e is an edge, e∈E represents a set of edges in a path, w(e, t) is a weight of an edge e at a time instant t, and f(v) is a complexity function related to a node v.

By adopting the above technical solution, the formula introduces weights of path edges at different time instants, which can reflect dynamic changes of complex paths over time and capture temporal characteristics in actual scenarios. By quantifying complexity related to nodes through a function, it ensures that the path complexity assessment relies not only on the path itself but also comprehensively considers the complex attributes of nodes. The formula can handle complex data lineage networks with multiple paths and multiple nodes, and is particularly suitable for large-scale, deep-level data governance scenarios. By combining edges on the path and node attributes, one-sided results caused by single-dimensional complexity assessment are avoided, providing a more comprehensive description of the complex characteristics of the data lineage graph. By calculating the data lineage path complexity, key high-complexity paths or nodes can be quickly located, providing clear directions for optimizing data flow. High-complexity paths may negatively affect data processing performance or governance efficiency, and the calculation result of this formula can serve as a basis for resource allocation and process optimization. The formula considers the characteristic that path edge weights change over time, enabling real-time analysis of complexity and adapting to dynamic changes in business requirements and data structures. Complexity assessment can be combined with real-time monitoring to provide data support for dynamic adjustment of governance strategies. Quantitative complexity assessment can help governance teams optimize data flow paths, reduce redundant operations, and improve data processing efficiency. Identifying complex paths helps to reduce quality attenuation or security risks caused by overly complex paths.

Optionally, the data global impact score is calculated by using the following formula:

$$I = {\sum }_{v ∈ {V}_{d}} {α}_{v} \cdot σ ( v ) + {\sum }_{k = 1}^{K} {β}_{k} \cdot {I}_{k}$$

wherein I is the data global impact score, V_{d} is a set of directly affected nodes, αᵥ is a weight coefficient of a node v, σ(v) is a sensitivity score of the node v, K is a maximum level of propagation, k is a k-th level, βₖ is a weight of the k-th level, and Iₖ is an impact score of the k-th level.

By adopting the above technical solution, the formula precisely assesses the influence scope and depth of data in the entire lineage graph by combining the set of directly affected nodes and propagation levels. The node weight coefficient and level weight assign differentiated weights to different nodes and levels, reflecting priorities and importance in actual business requirements. The node sensitivity score considers the importance of the data node in the business process, ensuring that the impact assessment is more aligned with actual scenarios. By giving high weight to sensitivity scores, it helps to quickly identify and prioritize the protection of data at key nodes, reducing the risk of data leakage or misuse. The formula introduces the maximum level and the impact score of each level, enabling a deep depiction of the global diffusion characteristics of data in a multi-level network. For complex multi-path lineage graphs, the formula can comprehensively assess the impact of different paths and levels without omitting any potentially critical nodes. The weight coefficients support real-time adjustment to adapt to dynamic changes in different business scenarios or data environments. In the event of data or business changes, the method can quickly recalculate the global impact score to ensure the timeliness of governance strategies. The data global impact score provides a quantitative basis for data governance priorities, helping to quickly identify key data nodes and paths that have the greatest impact on business. Based on the global impact score, governance resources can be concentrated on high-impact nodes or paths, improving governance efficiency and effectiveness. By identifying high-impact paths or nodes, global risks that may arise from cascading failures or misoperations can be timely discovered and mitigated. Data global impact analysis can help protect critical business data flow links and ensure the stable operation of core business.

Optionally, the data leakage risk score is calculated by using the following formula:

$$R = {\sum }_{v ∈ {V}_{s}} π ( v ) \cdot r ( v )$$

wherein R is the data leakage risk score, v is a node, Vₛ is a set of nodes containing sensitive data, π(v) is a probability that the node v is accessed, and r(v) is a leakage risk fraction of the node v.

By adopting the above technical solution, the formula focuses on the set of sensitive data nodes, clarifying that sensitive data is the core of leakage risk assessment and ensuring that resources are prioritized to protect high-risk data. The probability that a node is accessed reflects the dynamic nature of leakage risk, helping to accurately predict potential risks of frequently accessed data. The node access probability and leakage risk fraction can be dynamically updated based on real-time data, helping to respond to changing business environments and security threats. By combining access probability and leakage risk fraction, the frequency of data use and the inherent risk characteristics of the node are comprehensively considered. The calculation result can quickly locate nodes with the highest leakage risk, helping to formulate targeted security strategies and avoid dispersion and waste of resources. The formula provides a quantitative basis for sensitive data classification, permission control, and encryption protection, enhancing the scientific nature of security governance. By calculating the data leakage risk score in the data lineage graph, a global visualization map of data leakage risk can be generated, clearly showing high-risk nodes and their influence scopes. As node access behavior changes, the data leakage risk score can be updated in real time, helping the team continuously monitor and prevent potential security risks. The formula, based on the data lineage graph, extends the risk assessment of a single node to the entire data flow path, comprehensively considering leakage risks that may arise from cascading propagation. Focusing on sensitive data and access behavior helps enterprises better meet legal and compliance requirements for data privacy protection.

Optionally, the data usage efficiency score is calculated by using the following formula:

$$M = \frac{{\sum }_{t = 0}^{T} U ( t )}{{\sum }_{t = 0}^{T} C ( t )}$$

wherein M is the data usage efficiency score, T is a maximum time instant, t is a time instant, U(t) is a number of data accesses at the time instant t, and C(t) is a data maintenance cost at the time instant t.

By adopting the above technical solution, the formula combines the number of data accesses and data maintenance cost, providing a comprehensive quantitative assessment of data usage efficiency and avoiding the one-sidedness of considering only a single aspect. By comparing the number of accesses and maintenance cost, it identifies efficient data usage while helping to discover resource waste or excessive consumption. The formula introduces a time variable, which can capture dynamic changes in data usage efficiency at different time points, reflecting temporal characteristics. Over time, by dynamically calculating the efficiency score, data access and maintenance strategies can be discovered and optimized in real time. The formula can help quickly locate inefficient data with high maintenance cost and low access frequency, providing clear optimization directions for governance teams. Based on the efficiency score, data storage, computing, and operational resources can be reasonably allocated, improving overall data governance efficiency. The data usage efficiency score provides a scientific basis for data governance priorities, supporting hierarchical governance of efficient or inefficient data. Through time-series analysis of efficiency score changes, long-term trends can be identified, and more scientific resource investment and usage plans can be formulated. By analyzing data maintenance costs, costly operations can be identified and optimized in a targeted manner, thereby reducing overall operational expenses. Resources are concentrated on data that is frequently used and of higher value, avoiding excessive resource occupation by inefficient data.

Optionally, the generating a comprehensive data governance score based on the data quality propagation score, the data lineage path complexity, the data global impact score, the data leakage risk score, and the data usage efficiency score comprises: determining a ratio between the data quality propagation score and the data lineage path complexity; calculating a first product of the ratio and a first weight; calculating a second product of the data global impact score and a second weight; calculating a third product of the data leakage risk score and a third weight; calculating a fourth product of the data usage efficiency score and a fourth weight; and summing the first product, the second product, and the fourth product, and subtracting the third product, to obtain the comprehensive data governance score.

By adopting the above technical solution, the method comprehensively considers multiple key dimensions such as data quality propagation score, path complexity, global impact, leakage risk, and usage efficiency, fully reflecting the comprehensive status of data governance. By combining different dimensions in a weighted manner, the method achieves a balance among multiple indicators, avoiding the limitation of a single indicator deviating from reality. Different weight settings can reflect business objectives, such as placing greater emphasis on data quality or security, helping to make more precise decisions. The ratio of the data quality propagation score to the path complexity is used as an input, reflecting the propagation effect of data quality under the influence of path complexity, enhancing the logical rigor of the score. Through weighted summation and difference operations of different indicators, the scoring result is more scientific and can accurately reflect the merits of data governance. The comprehensive score provides an intuitive quantitative result for different data objects, which can be used for quick sorting and determining data governance priorities. Through comparative analysis of high-score and low-score data, it can help governance teams quickly locate governance areas that need focused attention. The comprehensive score can be updated in real time as individual indicator scores change, reflecting dynamic changes in data governance effectiveness and providing a basis for continuous optimization. The comprehensive score can help enterprises regularly evaluate the effectiveness of governance strategies and ensure gradual achievement of governance objectives. The comprehensive score provides a unified standard for data governance, facilitating communication and collaboration among different departments and teams. Based on the scoring results, governance resources can be preferentially allocated to high-priority data, significantly improving governance efficiency.

A second aspect of the present application provides a data governance apparatus based on data lineage, comprising: an acquisition module and a processing module, wherein the acquisition module is configured to acquire metadata of target data corresponding to a target governance requirement; the processing module is configured to construct a data lineage graph of the target data according to the metadata; the processing module is further configured to calculate, based on the data lineage graph, a data quality propagation score, a data lineage path complexity, a data global impact score, a data leakage risk score, and a data usage efficiency score of the target data; the processing module is further configured to generate a comprehensive data governance score based on the data quality propagation score, the data lineage path complexity, the data global impact score, the data leakage risk score, and the data usage efficiency score; and the processing module is further configured to perform data governance on the target data according to the comprehensive data governance score.

A third aspect of the present application provides an electronic device, comprising: a processor, a memory, a user interface, and a network interface, wherein the memory is configured to store instructions, the user interface and the network interface are both configured to communicate with other devices, and the processor is configured to execute the instructions stored in the memory to cause the electronic device to implement the method as described above.

A fourth aspect of the present application provides a computer-readable storage medium with instructions stored thereon, wherein when the instructions are executed, the method as described above is implemented.

### BRIEF DESCRIPTION OF THE DRAWINGS

FIG. 1 is a schematic flowchart of a data governance method based on data lineage according to an embodiment of the present application;

FIG. 2 is another schematic flowchart of a data governance method based on data lineage according to an embodiment of the present application;

FIG. 3 is a schematic module diagram of a data governance apparatus based on data lineage according to an embodiment of the present application;

FIG. 4 is a schematic structural diagram of an electronic device according to an embodiment of the present application.

List of Reference signs: 31, acquisition module; 32, processing module; 41, processor; 42, communication bus; 43, user interface; 44, network interface; 45, memory.

### DETAILED DESCRIPTION

In order to enable those skilled in the art to better understand the technical solutions in this specification, the technical solutions in the embodiments of this specification will be clearly and completely described below with reference to the accompanying drawings in the embodiments of this specification. Obviously, the described embodiments are only a part of the embodiments of the present application, rather than all the embodiments.

In the description of the embodiments of the present application, words such as “for example” or “by way of example” are used to present examples, illustrations, or explanations. Any embodiment or design described as “for example” or “by way of example” in the embodiments of the present application should not be construed as being more preferred or more advantageous than other embodiments or designs. Specifically, the use of words such as “for example” or “by way of example” is intended to present relevant concepts in a specific manner.

In the description of the embodiments of the present application, the term “a plurality of” means two or more. For example, a plurality of systems means two or more systems, and a plurality of screen terminals means two or more screen terminals. Furthermore, the terms “first” and “second” are used for descriptive purposes only and cannot be construed as indicating or implying relative importance or implicitly specifying the number of indicated technical features. Thus, a feature defined with “first” or “second” may explicitly or implicitly include one or more of such features. The terms “comprise,” “include,” “have,” and variations thereof all mean “including but not limited to,” unless specifically emphasized otherwise.

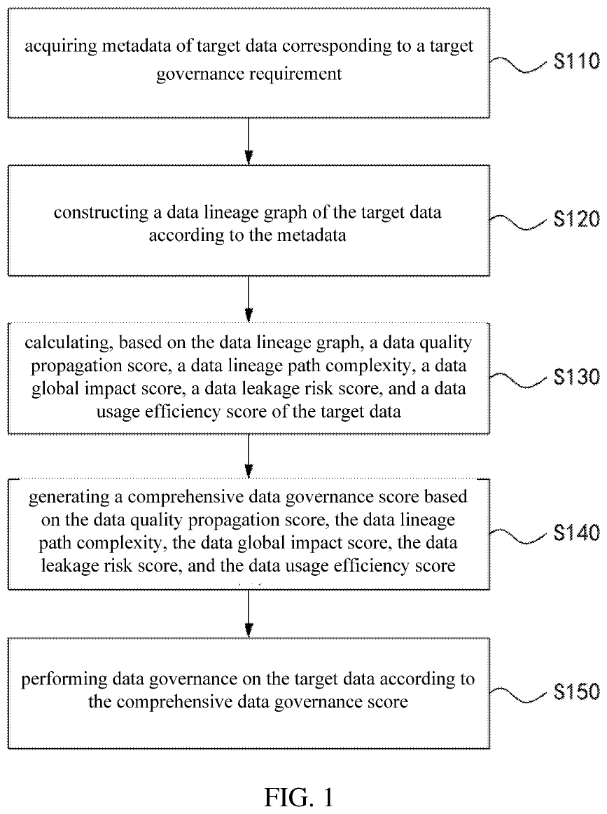

An embodiment of the present application provides a data governance method based on data lineage. FIG. 1 is a schematic flowchart of a data governance method based on data lineage according to an embodiment of the present application. The data governance method is applied to a server and comprises:
S110, acquiring metadata of target data corresponding to a target governance requirement.

Specifically, the server refers to a computing device or system that carries out data governance work, and it is the main execution unit for data analysis and processing. The target governance requirement is a specific requirement or issue for data governance, for example, improving data quality, optimizing query efficiency, reducing security risks, etc. The target data refers to a specific data set or data resource directly related to the governance requirement, such as a certain database table, a specific data file, etc. The metadata is data describing the target data, including data structure (table names, field names, field types); data source (data generation time, collection channel); data relationships (primary keys, foreign keys, dependency relationships); data operation logs (modification time, access frequency, etc.). The server acquires this metadata through interfaces or tools (such as a metadata management system) to provide support for subsequent data governance.

By way of example, assuming an enterprise wishes to optimize the efficiency of report generation in its financial system, the target governance requirement is to improve the efficiency of financial report generation and reduce generation latency. The target data is report-related data stored in the financial database, such as “income statement,” “expense statement,” etc. The server extracts the metadata of these data through a metadata management system or database management tool. The metadata includes the structure of the data tables, such as field names and field types, as well as data storage relationships, such as primary and foreign key relationships between tables. In addition, it includes data volume information, such as the number of rows in a data table and field sizes. It also includes data access logs, such as which queries frequently use these data and the access paths during report generation. The metadata is used to analyze the reasons for slow report generation, for example, whether it is due to missing indexes on certain fields or overly complex associated queries. At the same time, query paths can be optimized to reduce access to useless fields and improve data retrieval speed.
S120, constructing a data lineage graph of the target data according to the metadata.

Specifically, the server extracts information related to data lineage from the metadata, including: entity information, such as specific data entities like data tables, fields, and files; relationship information, dependency relationships between data entities, for example, a field in one table originates from another table; additional attributes, such as data generation time, operation records, sensitive information tags, etc. Each data entity serves as a node, for example, the table Sales is a node, and the field Revenue is another node. If one data entity depends on another data entity, an edge is added between the two. For example, the Revenue field is calculated from the Orders table through ETL. Based on the above nodes and edges, a graph structure is constructed and presented in a visual form. For example: intra-table lineage: a field depends on other fields; cross-table lineage: tables are connected through primary-foreign key relationships or ETL processes.

In an embodiment, the constructing a data lineage graph of the target data according to the metadata specifically comprises: parsing the metadata to obtain data entities, wherein the data entities comprise database tables, fields, and files; extracting edges according to data entities having dependency relationships among a plurality of the data entities; acquiring additional data between the data entities and the edges; determining attributes according to the additional data; and constructing the data lineage graph of the target data based on the data entities, the edges, and the attributes.

Specifically, the server parses the metadata to extract core information, including data entities and their relationships. The metadata may come from a database management system (DBMS), data warehouse tools, or logs of ETL processes. The data entities are specific constituent units of data, including: database tables: collections storing structured data, such as the order table Orders; fields: detailed units of data tables, such as OrderID, Price, etc.; files: unstructured or semi-structured data storage units, such as CSV, JSON files. The edges are dependency relationships between data entities, reflecting the flow of data from a source to a target. The edges may be defined by foreign key relationships, data calculation logic (such as ETL), application program operations, etc. The additional data describes the characteristics of data entities and edges, for example: edge weight: indicating the importance of the dependency relationship; timestamp: marking the update or processing time of data; operation type: insert, delete, modify, etc. The attributes are used to further characterize the features of nodes and edges, such as sensitivity of nodes and transmission efficiency of edges.

Further, first, the server parses the metadata and extracts data entities, extracting entity information such as data tables, fields, and files from the metadata and extracting basic descriptions of the entities (table names, field names, data types, etc.). Second, the server extracts dependency relationships between data entities, determining dependency relationships between data entities based on information in the metadata, such as foreign key relationships, ETL logs, or data processing scripts. Each dependency relationship is represented as an edge, and a direction from a source entity to a target entity is indicated. Then, the server acquires additional data, collecting additional information between entities and edges, such as data transmission frequency, access permission, or sensitivity level, and the calculation logic of the dependency relationship. The server uses the additional data to determine attributes of nodes (data entities) and edges (dependency relationships), for example, nodes: update time of tables, sensitivity level of fields; edges: dependency strength (such as higher weight for frequently invoked dependencies). Finally, the server takes the data entities as nodes, the dependency relationships as edges, and the attributes as features of the graph to generate the final data lineage graph. The data lineage graph is in the form of a directed graph, representing a full path of data from a source to a target.
S130, calculating, based on the data lineage graph, a data quality propagation score, a data lineage path complexity, a data global impact score, a data leakage risk score, and a data usage efficiency score of the target data.

Specifically, the server calculates, based on the data lineage graph, various scores of the target data, describing the process of multi-dimensional analysis based on the data lineage graph. The purpose of these scores is to comprehensively evaluate the performance of the target data in terms of quality, complexity, impact, risk, and usage efficiency through a quantitative manner, thereby providing a reliable basis for data governance. The data quality propagation score is used to evaluate the transmission and change of data quality along the data lineage path, reflecting the overall quality performance of data from source to target.

By tracking the flow path of data from upstream to downstream through the data lineage graph, the quality of each data entity is analyzed, and the impact of each path on the quality of the target data is considered. By way of example, SalesReport.NetProfit depends on Orders.Revenue and Products.Cost. If the data quality of Orders.Revenue is low (e.g., many missing values), this defect will propagate along the lineage path to NetProfit, resulting in a lower quality score. The data lineage path complexity is used to measure whether the lineage path structure of the target data is complex, including the number of nodes and edges, the depth of the path, and the complexity of dependency relationships. The server analyzes the topological structure of the data lineage graph, identifying the number of nodes and edges in the path, the depth of levels, and the nesting degree of relationships. Assuming that if the generation path of SalesReport.NetProfit is relatively complex, requiring passing through multiple intermediate nodes (such as Orders.Revenue and Products.Profit) and multiple edges, the complexity score will be higher. This means that during governance, the path needs to be optimized to reduce maintenance costs. The data global impact score is used to evaluate the impact scope and degree of changes or issues in the target data on the entire system. The server quantifies the impact of the target data on its downstream data entities and the overall system by analyzing the downstream nodes and paths in the data lineage graph. For example, assume Products. Cost is a key data source for SalesReport.NetProfit, and reports from multiple other departments also depend on Cost. If an error occurs in Cost, it will affect a large number of downstream reports, and its global impact score will be relatively high.

Further, the data leakage risk score is used to evaluate the potential leakage risk of the target data in the lineage path, especially the exposure probability of sensitive data. The server identifies sensitive data nodes involved in the lineage path and analyzes the frequency of data access, the security level of storage locations, and encryption and permission control during transmission. For example, if Products. Cost is a highly sensitive field and it is transmitted to SalesReport.NetProfit through an unencrypted path, there is a relatively high data leakage risk. The data usage efficiency score is used to measure the relationship between the usage value and maintenance cost of the target data in the system, reflecting the resource utilization efficiency of the data. The server counts the access frequency and call volume of the target data, and combines its storage and processing costs to analyze the data utilization efficiency. For example, if Orders.Revenue is accessed multiple times daily for different analysis tasks, but its storage and computing costs are low, the usage efficiency score is higher. Conversely, if some data, though computationally complex, is used infrequently, the efficiency score will decrease. By analyzing the data lineage graph, the server can evaluate the target data from multiple dimensions such as quality, structural complexity, global impact, leakage risk, and usage efficiency. These scores are quantitative analyses based on the data lineage graph, providing comprehensive control over the full data lifecycle, helping to identify key points and weak links in data governance, and providing a data-driven quantitative basis for data governance decisions.

In an embodiment, the data quality propagation score is specifically calculated by using the following formula:

$$Q = \frac{{\sum }_{i = 1}^{n} {q}_{i}}{n} \cdot {\prod }_{e ∈ E} ( 1 - d ( e ) )$$

wherein Q is the data quality propagation score, i is an i-th metadata item, qᵢ is a quality score of the i-th metadata item, n is a total number of metadata items, e is an edge, e∈E represents a set of edges in a path, and d(e) is a quality attenuation rate of a path edge e.

Specifically, the data quality propagation score is a quantitative indicator used to evaluate the attenuation and accumulation of data quality during the process of quality propagation from upstream source data to target data. The purpose is to measure the contribution of the quality of various data entities on the data lineage path to the quality of the target data and to consider the quality attenuation of data on each path. Wherein, the data quality propagation score represents the comprehensive quality of the target data. The i-th metadata item refers to each data entity or field in the lineage path. The quality score of the i-th metadata item is evaluated based on field completeness, accuracy, etc. The total number of metadata items is the number of nodes on the path. The edges in the path represent dependency relationships between data entities. The quality attenuation rate of a path edge e represents the degree of quality reduction during the transmission of data from upstream to downstream.

The server first extracts paths related to the target data from the data lineage graph, including upstream nodes (metadata) and edges (dependency relationships), and calculates a quality score for each metadata node. The quality score can be evaluated through the following dimensions: data completeness (whether there are missing values), data accuracy (whether it conforms to business logic), data consistency (whether it matches across systems). Next, the server analyzes the attenuation rate of each edge in the path. The attenuation rate may be related to information loss caused by data transformation (e.g., aggregation, filtering) and errors or deviations existing in data processing. Finally, the server comprehensively calculates the quality propagation score of the target data based on the quality scores of nodes in the path and the attenuation rates of edges.

In an embodiment, the data lineage path complexity is specifically calculated by using the following formula:

$$L = {\sum }_{e ∈ E} w ( e , t ) \cdot f ( v )$$

wherein L is the data lineage path complexity, t is a time instant, e is an edge, e∈E represents a set of edges in a path, w(e, t) is a weight of an edge e at a time instant t, and f(v) is a complexity function related to a node v.

Specifically, the data lineage path complexity is a quantitative indicator used to evaluate the complexity of the dependency path of the target data in the data lineage graph. It reflects the difficulty of data flow and dependency by analyzing edges, nodes, and their weights and complexity functions in the path. This complexity helps to identify and optimize complex paths in data governance, improving the efficiency and accuracy of data processing. The data lineage path complexity measures the overall complexity of the dependency path of the target data. The time instant is used to handle dynamic scenarios, reflecting changes in complexity over time. The weight of an edge e in the path at the time instant t represents the importance of a certain dependency relationship. For example, some edges may have greater weight due to high-frequency calls or higher importance. f(v) is a complexity function related to a node v, representing the inherent complexity of the node. For example, the number of fields contained in the data node, the difficulty of data operations involved in the node (such as aggregation, cleaning, etc.), and the computing resource consumption of the node.

Wherein, the server first extracts the path dependent on the target data from the data lineage graph, including edges e and nodes v. The server calculates the weight w(e, t) for each edge e in the path. The weight calculation may be based on the following factors: access frequency of the edge, with more frequent edges having higher weight; data volume size, with edges involving large data flows having higher weight. Then, the server evaluates the complexity f(v) of each node, possibly referencing the number of fields of the node, with more fields indicating higher complexity. For example, whether the node includes complex aggregation operations. Finally, the server combines the weights on the path and the node complexities, calculating the path complexity L according to the formula.

In an embodiment, the data global impact score is specifically calculated by using the following formula:

$$I = {\sum }_{v ∈ {V}_{d}} {α}_{v} \cdot σ ( v ) + {\sum }_{k = 1}^{K} {β}_{k} \cdot {I}_{k}$$

wherein I is the data global impact score, V_{d} is a set of directly affected nodes, αᵥ is a weight coefficient of a node v, σ(v) is a sensitivity score of the node v, K is a maximum level of propagation, k is a k-th level, βₖ is a weight of the k-th level, and Iₖ is an impact score of the k-th level.

Specifically, the data global impact score is a quantitative indicator used to measure the degree of impact of the target data on other data entities in the entire data lineage graph. The indicator performs a comprehensive assessment from two perspectives: direct impact and multi-level propagation, focusing on the set of nodes directly associated with the target data (directly affected nodes), as well as the comprehensive impact of each level as the impact propagates layer by layer along the path. The data global impact score measures the global influence of the target data in the entire data lineage graph. The set of nodes directly affected by the target data includes entities directly associated with the target data. The weight coefficient of a node v represents the importance of the node, for example, the weight of a core business node may be higher, and the weight of a non-critical field node may be lower. The sensitivity score of a node v is used to evaluate the sensitivity of the node to data quality changes, for example, a node where a data error has a greater impact on business has higher sensitivity. K is the maximum level of propagation, defining the depth of influence propagation, depending on the complexity of the business scenario. The weight of the k-th level reflects the propagation importance of that level. For example, a level farther from the target data may have a lower weight. The impact score of the k-th level represents the comprehensive impact of all nodes at the k-th level.

The server first starts from the target data and finds all nodes directly related to it. These nodes are directly affected by changes in the target data. Then, the server calculates the influence for each directly affected node, where the weight and sensitivity together determine the importance of the node. Next, the server calculates the impact score of influence propagating to different levels layer by layer, where the impact score of each layer is the combined value of the impact of all nodes at that layer. Level weights are used to adjust the contribution of each layer's propagation. Finally, the server performs a weighted summation of the direct impact and the layer-by-layer propagation impact to obtain the global impact score I.

In an embodiment, the data leakage risk score is specifically calculated by using the following formula:

$$R = {\sum }_{v ∈ {V}_{s}} π ( v ) \cdot r ( v )$$

wherein R is the data leakage risk score, v is a node, Vₛ is a set of nodes containing sensitive data, π(v) is a probability that the node v is accessed, and r(v) is a leakage risk fraction of the node v.

Specifically, the data leakage risk score is an indicator used to evaluate the degree of leakage risk of the target data or its related nodes in the data lineage graph. The score comprehensively considers the following factors, such as the set of sensitive data nodes in the data lineage graph, and the probability that each node is accessed reflects its exposure degree, while the inherent leakage risk fraction of each node represents the impact of data characteristics on the likelihood of leakage. By summing the products of access probability and leakage risk fraction for nodes in the sensitive node set, the comprehensive risk of sensitive data leakage in the entire data lineage graph is obtained. The data leakage risk score measures the overall leakage likelihood of the target data. The nodes in the data lineage graph represent data entities (such as tables, fields, or files), and the set of nodes containing sensitive data includes, for example, fields involving personal privacy such as user_id, email_address; tables involving trade secrets such as financial_records; and the probability that a node v is accessed. The access probability can be estimated based on logs, permission assignments, or historical records. The leakage risk fraction of a node v depends on the data type, storage security, and its potential impact in a leakage scenario. The essence of the formula is to sum the products of access probability and leakage risk for all nodes in the sensitive node set.

The server first identifies the set of sensitive data nodes, i.e., extracts sensitive information from the metadata, such as marking nodes containing identity information, financial information, etc. The server classifies data according to business rules or sensitivity grading. The server calculates historical access frequency based on access logs and considers user permission distribution to calculate the probability of the node being exposed to users. Next, the server comprehensively considers factors such as data storage method, encryption strategy, security vulnerabilities, etc. For example, an unencrypted field has a higher leakage risk fraction, while an encrypted field or a field with lower sensitivity classification has a lower risk fraction. Finally, the server sums the products of access probability and leakage risk fraction for each node in the sensitive node set to obtain the overall data leakage risk score R.

In an embodiment, the data usage efficiency score is specifically calculated by using the following formula:

$$M = \frac{{\sum }_{t = 0}^{T} U ( t )}{{\sum }_{t = 0}^{T} C ( t )}$$

wherein M is the data usage efficiency score, T is a maximum time instant, t is a time instant, U(t) is a number of data accesses at the time instant t, and C(t) is a data maintenance cost at the time instant t.

Specifically, the data usage efficiency score is an indicator used to measure the actual utilization efficiency of the target data at different time points. By calculating the ratio of the number of data accesses to maintenance cost and incorporating the time dimension, the rationality of the usage value and resource investment of the data is evaluated. The data usage efficiency score represents the comprehensive utilization efficiency of the target data. The maximum time instant refers to the last time point in the data lifecycle or monitoring period. The time instant t is used to segment the usage of data. The number of data accesses at the time instant t reflects the usage frequency of the data. The data maintenance cost at the time instant t represents the resource consumption of the data at that time point, such as storage, backup, or computing resources. The formula measures whether the data has been efficiently utilized during its lifecycle by summing the ratios of the number of accesses to maintenance cost by time instant.

The server first collects data access logs, extracts access records from databases, file systems, or data lakes, and counts the access frequency by time instant. For example, if a certain table is accessed 10 times per day, then U(t)=10. Second, the server analyzes data storage and operational resource consumption, such as hardware, network bandwidth, and computing processing. For example, if the data storage cost is 5 yuan per GB per day, the cost can be calculated by storage amount C(t)=5×storage amount. Then, the server divides the number of accesses by the maintenance cost at each time point t to obtain the data usage efficiency at that time instant. Finally, the server sums the single-instant efficiencies of all time instants to obtain the total data usage efficiency score M.
S140, generating a comprehensive data governance score based on the data quality propagation score, the data lineage path complexity, the data global impact score, the data leakage risk score, and the data usage efficiency score.

Specifically, the comprehensive data governance score is a result of comprehensive quantitative evaluation of the target data from multiple dimensions, which comprehensively considers the performance of five dimensions: data quality, data complexity, data global impact, leakage risk, and usage efficiency. The server generates a unified indicator by calculating the weighted sum and difference of these scores as a basis for assessment and decision-making.

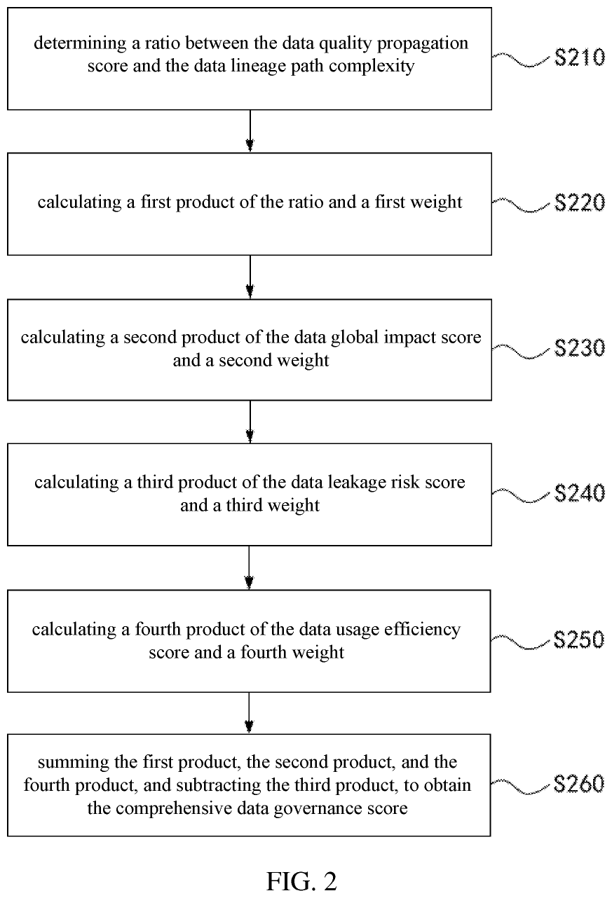

In an embodiment, FIG. 2 shows another schematic flowchart of a data governance method based on data lineage. The generating a comprehensive data governance score based on the data quality propagation score, the data lineage path complexity, the data global impact score, the data leakage risk score, and the data usage efficiency score specifically comprises: S210, determining a ratio between the data quality propagation score and the data lineage path complexity; S220, calculating a first product of the ratio and a first weight; S230, calculating a second product of the data global impact score and a second weight; S240, calculating a third product of the data leakage risk score and a third weight; S250, calculating a fourth product of the data usage efficiency score and a fourth weight; S260, summing the first product, the second product, and the fourth product, and subtracting the third product, to obtain the comprehensive data governance score.

Specifically, the server performs a ratio operation on the data quality propagation score and the data lineage path complexity to reflect the level of data quality relative to data complexity. The purpose is to identify whether the data still maintains relatively high quality in a relatively complex lineage structure. The first weight is the weight of the ratio of data quality to complexity, indicating the importance of this part of the ratio. The second weight is the weight of the data global impact score, reflecting the emphasis on the global impact of the data on other parts of the system. The third weight is the weight of the data leakage risk score, used to measure the security risk of sensitive data. The fourth weight is the weight of the data usage efficiency score, indicating the emphasis on the actual usage value of the data. The above weights can be customized according to the target data governance requirements. The server sums the above weighted product results, summarizing the contributions of each dimension to the comprehensive score. At the same time, the product result of the leakage risk weight is subtracted, because data leakage risk is a negative impact and should be deducted. Finally, a quantitative comprehensive score is obtained, and a higher value indicates that the data has a higher priority in governance.

By way of example, assuming the comprehensive score is 39.6, which is higher than a preset score threshold, it indicates that this customer data table has a relatively high priority in data governance. Reasons include a relatively high data quality propagation, relatively controllable path complexity, significant global impact with strong correlations to other parts of the system, high usage efficiency with relatively high access frequency and manageable maintenance cost. The leakage risk score has some hidden risks, but overall it is still high-priority data. Therefore, by comprehensively considering multi-dimensional data performance, the one-sidedness of a single indicator is αvoided. The weight configuration is flexible and can balance the governance objectives of different enterprises, such as emphasizing quality, efficiency, or security. It supports complex data environments, such as multi-table dependencies, high access frequency, or high-risk data. Subjective interference is eliminated, making the decision-making process of data governance more scientific and efficient. Wherein, priority is given to governing high-impact data, such as data related to core business. High-risk data is quickly identified, such as planning resources in advance for security reinforcement. Data governance efficiency is improved, such as directly locating high-value data through scores to enhance governance effectiveness.
S150, performing data governance on the target data according to the comprehensive data governance score.

Specifically, the server, based on the previously calculated comprehensive data governance score, allocates governance resources, determines governance strategies, or adjusts governance priorities for the target data according to the score level. The objectives of data governance include: improving data quality, such as repairing errors in data, deleting duplicate data, completing missing data, etc.; optimizing data structure, such as optimizing data lineage paths and reducing complexity; enhancing data security, such as strengthening protection of sensitive data and reducing data leakage risks; improving usage efficiency, such as reducing unnecessary data storage or redundancy and increasing access efficiency.

The server screens high-priority data by sorting the comprehensive scores of all data, with higher-scoring target data being governed first. High-priority data may be allocated more manpower, computing resources, and time. Low-priority data may be handled using automated batch governance tools to reduce governance costs. The server takes targeted governance measures based on the characteristics of the data and the composition of the score. In an Example 1, if a certain data score is low mainly due to a low quality propagation score, the server focuses on repairing errors in the data. In an Example 2, if the score is low due to a low data leakage risk score, the server strengthens access permission control on the data. During the governance process, the score can be dynamically adjusted. If governance measures are effective, the score will improve, and the server can update the strategy in a timely manner.

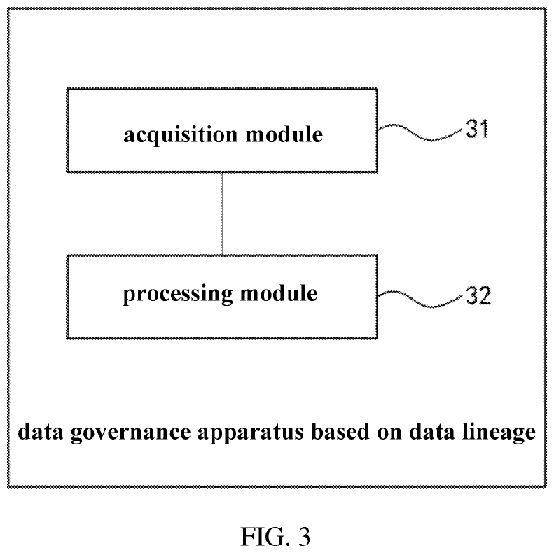

The present application also provides a data governance apparatus based on data lineage. FIG. 3 is a schematic module diagram of a data governance apparatus based on data lineage according to the present application. The data governance apparatus is a server, and the server comprises an acquisition module 31 and a processing module 32, wherein the acquisition module 31 acquires metadata of target data corresponding to a target governance requirement; the processing module 32 constructs a data lineage graph of the target data according to the metadata; the processing module 32 calculates, based on the data lineage graph, a data quality propagation score, a data lineage path complexity, a data global impact score, a data leakage risk score, and a data usage efficiency score of the target data; the processing module 32 generates a comprehensive data governance score based on the data quality propagation score, the data lineage path complexity, the data global impact score, the data leakage risk score, and the data usage efficiency score; and the processing module 32 performs data governance on the target data according to the comprehensive data governance score.

In an embodiment, the processing module 32 constructing a data lineage graph of the target data according to the metadata specifically comprises: the processing module 32 parses the metadata to obtain data entities, wherein the data entities comprise database tables, fields, and files; the processing module 32 extracts edges according to data entities having dependency relationships among a plurality of the data entities; the acquisition module 31 acquires additional data between the data entities and the edges; the processing module 32 determines attributes according to the additional data; the processing module 32 constructs the data lineage graph of the target data based on the data entities, the edges, and the attributes.

In an embodiment, the processing module 32 calculates, based on the data lineage graph, a data quality propagation score, a data lineage path complexity, a data global impact score, a data leakage risk score, and a data usage efficiency score of the target data, and the data quality propagation score is specifically calculated by using the following formula:

$$Q = \frac{{\sum }_{i = 1}^{n} {q}_{i}}{n} \cdot {\prod }_{e ∈ E} ( 1 - d ( e ) )$$

wherein Q is the data quality propagation score, i is an i-th metadata item, qᵢ is a quality score of the i-th metadata item, n is a total number of metadata items, e is an edge, e∈E represents a set of edges in a path, and d(e) is a quality attenuation rate of a path edge e.

In an embodiment, the processing module 32 calculates, based on the data lineage graph, a data quality propagation score, a data lineage path complexity, a data global impact score, a data leakage risk score, and a data usage efficiency score of the target data, and the data lineage path complexity is specifically calculated by using the following formula:

$$L = {\sum }_{e ∈ E} w ( e , t ) \cdot f ( v )$$

wherein L is the data lineage path complexity, t is a time instant, e is an edge, e∈E represents a set of edges in a path, w(e, t) is a weight of an edge e at a time instant t, and f(v) is a complexity function related to a node v.

In an embodiment, the processing module 32 calculates, based on the data lineage graph, a data quality propagation score, a data lineage path complexity, a data global impact score, a data leakage risk score, and a data usage efficiency score of the target data, and the data global impact score is specifically calculated by using the following formula:

$$I = {\sum }_{v ∈ {V}_{d}} {α}_{v} \cdot σ ( v ) + {\sum }_{k = 1}^{K} {β}_{k} \cdot {I}_{k}$$

wherein I is the data global impact score, V_{d} is a set of directly affected nodes, αᵥ is a weight coefficient of a node v, σ(v) is a sensitivity score of the node v, K is a maximum level of propagation, k is a k-th level, βₖ is a weight of the k-th level, and Iₖ is an impact score of the k-th level.

In an embodiment, the processing module 32 calculates, based on the data lineage graph, a data quality propagation score, a data lineage path complexity, a data global impact score, a data leakage risk score, and a data usage efficiency score of the target data, and the data leakage risk score is specifically calculated by using the following formula:

$$R = {\sum }_{v ∈ {V}_{s}} π ( v ) \cdot r ( v )$$

wherein R is the data leakage risk score, v is a node, Vₛ is a set of nodes containing sensitive data, π(v) is a probability that the node v is accessed, and r(v) is a leakage risk fraction of the node v.

In an embodiment, the processing module 32 calculates, based on the data lineage graph, a data quality propagation score, a data lineage path complexity, a data global impact score, a data leakage risk score, and a data usage efficiency score of the target data, and the data usage efficiency score is specifically calculated by using the following formula:

$$M = \frac{{\sum }_{t = 0}^{T} U ( t )}{{\sum }_{t = 0}^{T} C ( t )}$$

wherein M is the data usage efficiency score, T is a maximum time instant, t is a time instant, U(t) is a number of data accesses at the time instant t, and C(t) is a data maintenance cost at the time instant t.

In an embodiment, the processing module 32 generates a comprehensive data governance score based on the data quality propagation score, the data lineage path complexity, the data global impact score, the data leakage risk score, and the data usage efficiency score, which specifically comprises: the processing module 32 determines a ratio between the data quality propagation score and the data lineage path complexity; the processing module 32 calculates a first product of the ratio and a first weight; the processing module 32 calculates a second product of the data global impact score and a second weight; the processing module 32 calculates a third product of the data leakage risk score and a third weight; the processing module 32 calculates a fourth product of the data usage efficiency score and a fourth weight; the processing module 32 sums the first product, the second product, and the fourth product, and subtracts the third product, to obtain the comprehensive data governance score.

It should be noted that the apparatus provided in the above embodiments, when implementing its functions, is only illustrated by the division of the above functional modules. In practical applications, the above functions can be allocated to different functional modules as needed, that is, the internal structure of the device is divided into different functional modules to complete all or part of the functions described above. In addition, the apparatus and method embodiments provided in the above embodiments belong to the same concept, and the specific implementation process is detailed in the method embodiments, which will not be repeated here.

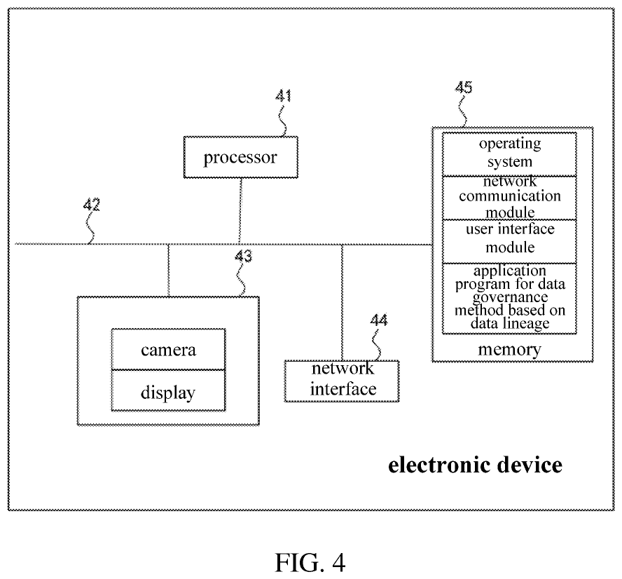

The present application also provides an electronic device. Referring to FIG. 4, a schematic structural diagram of an electronic device according to an embodiment of the present application is shown. The electronic device may include: at least one processor 41, at least one network interface 44, a user interface 43, a memory 45, and at least one communication bus 42.

The communication bus 42 is used to realize connection and communication among these components.

The user interface 43 may include a display screen and a camera. Optionally, the user interface 43 may also include a standard wired interface and a wireless interface.

The network interface 44 may optionally include a standard wired interface and a wireless interface (such as a WI-FI interface).

The processor 41 may include one or more processing cores. The processor 41 uses various interfaces and lines to connect various parts within the entire server, and executes various functions of the server and processes data by running or executing instructions, programs, code sets, or instruction sets stored in the memory 45, and calling data stored in the memory 45. Optionally, the processor 41 may be implemented in at least one hardware form of Digital Signal Processing (DSP), Field-Programmable Gate Array (FPGA), or Programmable Logic Array (PLA). The processor 41 may integrate one or a combination of a Central Processing Unit (CPU), a Graphics Processing Unit (GPU), and a modem, etc. Wherein, the CPU mainly processes the operating system, user interface, and application programs, etc.; the GPU is responsible for rendering and drawing the content to be displayed on the display screen; the modem is used to handle wireless communication. It is understandable that the modem may also not be integrated into the processor 41 and may be implemented separately through a chip.

The memory 45 may include Random Access Memory (RAM) and may also include Read-Only Memory (ROM). Optionally, the memory 45 includes a non-transitory n computer-readable storage medium. The memory 45 may be used to store instructions, programs, code, code sets, or instruction sets. The memory 45 may include a program storage area and a data storage area, wherein the program storage area may store instructions for implementing the operating system, instructions for at least one function (such as a touch function, a sound playback function, an image playback function, etc.), instructions for implementing the above method embodiments, etc.; the data storage area may store data involved in the above method embodiments, etc. Optionally, the memory 45 may also be at least one storage device located remotely from the processor 41. As shown in FIG. 4, the memory 45, as a computer storage medium, may include an operating system, a network communication module, a user interface module, and an application program of a data governance method based on data lineage.

In the electronic device shown in FIG. 4, the user interface 43 is mainly used to provide an input interface for the user and acquire data input by the user; and the processor 41 may be used to call the application program of the data governance method based on data lineage stored in the memory 45, which, when executed by one or more processors, causes the electronic device to execute the method described in one or more of the above embodiments.

It should be noted that, for the sake of simple description, the foregoing method embodiments are all expressed as a series of action combinations. However, those skilled in the art should be aware that the present application is not limited by the described order of actions, because according to the present application, certain steps may be performed in other orders or simultaneously. Second, those skilled in the art should also be aware that the embodiments described in the specification are all preferred embodiments, and the actions and modules involved are not necessarily essential to the present application.

The present application also provides a computer-readable storage medium with instructions stored thereon. When executed by one or more processors, the instructions cause an electronic device to implement the method described in one or more of the above embodiments.

In the above embodiments, the description of each embodiment has its own emphasis. For parts not detailed in a certain embodiment, reference may be made to the relevant descriptions of other embodiments.

In the several embodiments provided in the present application, it should be understood that the disclosed apparatus may be implemented in other ways. For example, the apparatus embodiments described above are merely illustrative. For example, the division of units is only a logical function division. In actual implementation, there may be other division methods, for example, multiple units or components may be combined or integrated into another system, or some features may be omitted or not executed. Another point is that the coupling or direct coupling or communication connection shown or discussed may be indirect coupling or communication connection through some service interfaces, devices, or units, which may be electrical or in other forms.

Units described as separate components may or may not be physically separate. Components shown as units may or may not be physical units, that is, they may be located in one place, or may be distributed to multiple network units. Some or all of the units may be selected according to actual needs to achieve the objectives of the solutions of the embodiments.

In addition, various functional units in the various embodiments of the present application may be integrated into one processing unit, or each unit may exist physically alone, or two or more units may be integrated into one unit. The integrated unit may be implemented in the form of hardware or in the form of a software functional unit.

If the integrated unit is implemented in the form of a software functional unit and sold or used as an independent product, it may be stored in a computer-readable memory. Based on such an understanding, the technical solution of the present application essentially or the part that contributes to the prior art, or all or part of the technical solution, may be embodied in the form of a software product. The computer software product is stored in a memory and includes several instructions to cause a computer device (which may be a personal computer, a server, or a network device, etc.) to execute all or part of the steps of the methods of the various embodiments of the present application. The aforementioned memory includes various media capable of storing program code, such as a USB flash drive, a mobile hard disk, a magnetic disk, or an optical disk.

The above description is only exemplary embodiments of the present disclosure and should not be used to limit the scope of the present disclosure. That is, any equivalent changes and modifications made according to the teachings of the present disclosure shall still fall within the scope of the present disclosure. Those skilled in the art, after considering the specification and practicing the truth disclosed herein, will readily conceive of other embodiments of the present disclosure. The present application is intended to cover any variations, uses, or adaptations of the present disclosure, which follow the general principles of the present disclosure and include common knowledge or customary technical means in the art that are not disclosed in the present disclosure. The specification and embodiments are to be regarded as exemplary only, and the scope and spirit of the present disclosure are defined by the claims.

1. A data governance method based on data lineage, comprising:
acquiring metadata of target data corresponding to a target governance requirement;
constructing a data lineage graph of the target data according to the metadata;
calculating, based on the data lineage graph, a data quality propagation score, a data lineage path complexity, a data global impact score, a data leakage risk score, and a data usage efficiency score of the target data;
generating a comprehensive data governance score based on the data quality propagation score, the data lineage path complexity, the data global impact score, the data leakage risk score, and the data usage efficiency score; and
performing data governance on the target data according to the comprehensive data governance score.

2. The data governance method based on data lineage according to claim 1, wherein the constructing the data lineage graph of the target data according to the metadata comprises:
parsing the metadata to obtain data entities, wherein the data entities comprise database tables, fields, and files;
extracting edges according to data entities having dependency relationships among a plurality of the data entities;
acquiring additional data between the data entities and the edges;
determining attributes according to the additional data; and
constructing the data lineage graph of the target data based on the data entities, the edges, and the attributes.

3. The data governance method based on data lineage according to claim 2, wherein the dependency relationships are defined by at least one of foreign key relationships, extract, transform, load (ETL) process logs, or application program operations; the additional data comprises at least one of edge weight, timestamp, operation type, data transmission frequency, access permission, or sensitivity level; and the attributes are used for characterizing features of nodes and the edges, comprising sensitivity of the nodes and transmission efficiency of the edges.

4. The data governance method based on data lineage according to claim 1, wherein the constructing the data lineage graph of the target data further comprises:
taking the data entities as nodes;
taking dependency relationships as edges, and indicating a direction from a source entity to a target entity; and
taking attributes as features of the data lineage graph to generate the data lineage graph in a form of a directed graph, wherein the directed graph represents a full path of data from a source to a target.

5. The data governance method based on data lineage according to claim 1, wherein the data quality propagation score is calculated by using the following formula:
$$Q = \frac{{\sum }_{i = 1}^{n} {q}_{i}}{n} \cdot {\prod }_{e ∈ E} ( 1 - d ( e ) )$$
wherein Q is the data quality propagation score, i is an i-th metadata item, qᵢ is a quality score of the i-th metadata item, n is a total number of metadata items, e is an edge, e∈E represents a set of edges in a path, and d(e) is a quality attenuation rate of a path edge e.

6. The data governance method based on data lineage according to claim 5, wherein, in the calculation of the data quality propagation score, the quality score of the i-th metadata item is evaluated based on at least one of field completeness, data accuracy, or data consistency, the field completeness evaluates whether data has missing values, the data accuracy evaluates whether the data conforms to business logic, and the data consistency evaluates whether the data matches across systems.

7. The data governance method based on data lineage according to claim 1, wherein the data lineage path complexity is calculated by using the following formula:
$$L = {\sum }_{e ∈ E} w ( e , t ) \cdot f ( v )$$
wherein L is the data lineage path complexity, t is a time instant, e is an edge, e∈E represents a set of edges in a path, w(e, t) is a weight of the edge e at the time instant t, and f(v) is a complexity function related to a node v.

8. The data governance method based on data lineage according to claim 7, wherein, in the calculation of the data lineage path complexity, the weight w(e, t) is dynamically adjusted based on an access frequency and a data volume size of the edge, and the complexity function f(v) is determined based on a number of fields of the node and an operation difficulty.

9. The data governance method based on data lineage according to claim 1, wherein the data global impact score is calculated by using the following formula:
$$I = {\sum }_{v ∈ {V}_{d}} {α}_{v} \cdot σ ( v ) + {\sum }_{k = 1}^{K} {β}_{k} \cdot {I}_{k}$$
wherein I is the data global impact score, V_{d} is a set of directly affected nodes, αᵥ is a weight coefficient of a node v, σ(v) is a sensitivity score of the node v, K is a maximum level of propagation, k is a k-th level, βₖ is a weight of the k-th level, and Iₖ is an impact score of the k-th level.

10. The data governance method based on data lineage according to claim 9, wherein, in the calculation of the data global impact score, the weight coefficient of the node v represents an importance of the node, a weight of a core business node is higher than a weight of a non-critical field node; the sensitivity score of the node v is evaluated based on a degree of impact of a data error on business, a node having a greater impact of the data error on business has a higher sensitivity score; and the weight of the k-th level reflects propagation importance of the k-th level, a level farther from the target data has a lower weight.

11. The data governance method based on data lineage according to claim 1, wherein the data leakage risk score is calculated by using the following formula:
$$R = {\sum }_{v ∈ {V}_{s}} π ( v ) \cdot r ( v )$$
wherein R is the data leakage risk score, v is a node, Vₛ is a set of nodes containing sensitive data, π(v) is a probability that the node v is accessed, and r(v) is a leakage risk fraction of the node v.

12. The data governance method based on data lineage according to claim 1, wherein the data usage efficiency score is calculated by using the following formula:
$$M = \frac{{\sum }_{t = 0}^{T} U ( t )}{{\sum }_{t = 0}^{T} C ( t )}$$
wherein M is the data usage efficiency score, T is a maximum time instant, t is a time instant, U(t) is a number of data accesses at the time instant t, and C(t) is a data maintenance cost at the time instant t.

13. The data governance method based on data lineage according to claim 1, wherein the generating the comprehensive data governance score based on the data quality propagation score, the data lineage path complexity, the data global impact score, the data leakage risk score, and the data usage efficiency score comprises:
determining a ratio between the data quality propagation score and the data lineage path complexity;
calculating a first product of the ratio and a first weight;
calculating a second product of the data global impact score and a second weight;
calculating a third product of the data leakage risk score and a third weight;
calculating a fourth product of the data usage efficiency score and a fourth weight; and
summing the first product, the second product, and the fourth product, and subtracting the third product, to obtain the comprehensive data governance score.

14. The data governance method based on data lineage according to claim 13, wherein the method further comprises:
dynamically adjusting the first weight, the second weight, the third weight, and the fourth weight according to a change of a data governance requirement or an indicator to obtain adjusted weights; and
recalculating the comprehensive data governance score based on the adjusted weights to adapt to governance objectives at different stages.

15. A data governance apparatus based on data lineage, comprising: an acquisition module and a processing module, wherein,
the acquisition module is configured to acquire metadata of target data corresponding to a target governance requirement;
the processing module is configured to construct a data lineage graph of the target data according to the metadata;
the processing module is further configured to calculate, based on the data lineage graph, a data quality propagation score, a data lineage path complexity, a data global impact score, a data leakage risk score, and a data usage efficiency score of the target data;
the processing module is further configured to generate a comprehensive data governance score based on the data quality propagation score, the data lineage path complexity, the data global impact score, the data leakage risk score, and the data usage efficiency score; and
the processing module is further configured to perform data governance on the target data according to the comprehensive data governance score.

16. The data governance apparatus based on data lineage according to claim 15, wherein the processing module is configured to calculate the data quality propagation score by using the following calculation formula:
$$Q = \frac{{\sum }_{i = 1}^{n} {q}_{i}}{n} \cdot {\prod }_{e ∈ E} ( 1 - d ( e ) )$$
wherein Q is the data quality propagation score, i is an i-th metadata item, qᵢ is a quality score of the i-th metadata item, n is a total number of metadata items, e is an edge, e∈E represents a set of edges in a path, and d(e) is a quality attenuation rate of a path edge e.

17. The data governance apparatus based on data lineage according to claim 15, wherein the processing module is configured to calculate the data lineage path complexity by using the following calculation formula:
$$L = {\sum }_{e ∈ E} w ( e , t ) \cdot f ( v )$$
wherein L is the data lineage path complexity, t is a time instant, e is an edge, e∈E represents a set of edges in a path, w(e, t) is a weight of the edge e at the time instant t, and f(v) is a complexity function related to a node v.

18. The data governance apparatus based on data lineage according to claim 15, wherein the processing module is configured to calculate the data global impact score by using the following calculation formula:
$$I = {\sum }_{v ∈ {V}_{d}} {α}_{v} \cdot σ ( v ) + {\sum }_{k = 1}^{K} {β}_{k} \cdot {I}_{k}$$
wherein I is the data global impact score, V_{d} is a set of directly affected nodes, αᵥ is a weight coefficient of a node v, σ(v) is a sensitivity score of the node v, K is a maximum level of propagation, k is a k-th level, βₖ is a weight of the k-th level, and Iₖ is an impact score of the k-th level.

19. The data governance apparatus based on data lineage according to claim 15, wherein the processing module is configured to calculate the data usage efficiency score by using the following calculation formula:
$$M = \frac{{\sum }_{t = 0}^{T} U ( t )}{{\sum }_{t = 0}^{T} C ( t )}$$
wherein M is the data usage efficiency score, T is a maximum time instant, t is a time instant, U(t) is a number of data accesses at the time instant t, and C(t) is a data maintenance cost at the time instant t.

20. An electronic device, comprising a processor, a memory, a user interface, and a network interface, wherein the memory is configured to store instructions, the user interface and the network interface are both configured to communicate with other devices, and the processor is configured to execute the instructions stored in the memory to cause the electronic device to implement the data governance method based on data lineage according to claim 1.
